(19) United States
(12) Patent Application Publication
(10) Pub. No.: US 2010/0318974 A1
(43) Pub. Date: Dec. 16, 2010

(54) BUSINESS OBJECT MOCKUP ARCHITECTURE

(75) Inventors: Jan Hrastnik, Burscheid (DE); Adam Polly, Stutensee-Blankenloch (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/485,743

(22) Filed: Jun. 16, 2009

(51) Int. Cl. G06F 9/44; G06F 9/46

(52) U.S. Cl. 717/135; 719/316

(57) ABSTRACT

Business objects are decoupled from hierarchical structural elements and coupled to simulated structural elements to provide a stable testing environment. Testing data is provided within the simulated structural environment to enable consistency and accuracy in testing and developing business objects.

### TECHNICAL FIELD

The present disclosure relates to software for business object testing and development and, more particularly, to software for providing a stable testing and development environment by decoupling business object functionality from business object dependencies.

### BACKGROUND

In certain service-oriented architectures (SOAs), business objects form the basis for modeling and running processes within as well as on top of enterprise service infrastructures. Within these processes, business objects are often tightly coupled and interact with each other. Service providers that are not completely implemented, are not stable (e.g. showing runtime errors), or do not provide the data the test relies upon would be inadequate testing and development environments for business objects. If a dependent object does not work as expected or provides syntax errors during runtime, this can prevent the hosting business object from being tested. Other business objects that access the hosting business object may also not work. This also holds true for example enhanced controller objects (ECOs), or the like, that engage one of the corrupted business objects and the user interface (UI) that is built on top of these ECOs. Services and functions within the application platform, as well as within that solution, can be very sensitive to errors in underlying layers and functionalities. Furthermore, it is often difficult to find the reason for why the functionality does not work properly. Accordingly, tests of individual business objects benefit from a stable environment.

### SUMMARY

The disclosure provides various embodiments of software for providing a simulated business objects for developing and testing business objects by decoupling requests for service from service providers and rerouting the requests to a business object mockup framework. In embodiments, there is provided software embodied in a computer-readable medium, comprising instructions being operable when executed to cause a processor to receive a request from a consumer for a business process performed by a business object service provider, redirect the request to a simulated business object service provider framework, the simulated business object service provider framework providing a plurality of simulated business object service provider functionalities to perform the business process, and process the request using the simulated business object service provider functionality to test business object functionality related to the request from the consumer or the business process.

In another aspect of the disclosure, there is provided software embodied in a computer-readable medium, the software comprising instructions being operable when executed to cause a processor to instantiate a mockup business object service provider instance, the mockup business object service provider instance operable to perform a business process, retrieve business process data from a data repository, and provide the mockup business object service provider instance and the business process data to a business object testing environment, the business object testing environment selectively utilized during a business process execution to decouple a request for the business process directed to a production business object service provider operable to carry out the business process, and perform the business process using the mockup business object service provider instance and the business process data.

While generally described as computer implemented software embodied on tangible media that facilitates testing of service consumers by decoupling them from their service providers and providing them with stable test data, some or all of the aspects may be computer implemented methods or further included in respective systems or other devices for executing or performing this described functionality. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 is a diagram of an example business enterprise environment implementing various features of the business object mockup framework within the context of the present disclosure.

FIG. 2 is a schematic representation of one business object architecture for use by an appropriate system, such as the system described in FIG. 1.

FIG. 3A are diagrams illustrating an example business enterprise application architecture for use by an appropriate system, such as the system described in FIG. 1.

FIG. 3B is a diagram showing a more detailed example of a business enterprise application architecture with an implementation of the business object mockup framework illustrating a core service provider switch for use by an appropriate system, such as the system described in FIG. 1.

FIG. 4 is a data flow diagram illustrating example components of an embodiment of the business mockup framework for implementing design-time test development within a particular implementation of the present disclosure.

FIG. 5 is a data flow diagram illustrating example components of an embodiment of the business mockup framework for implementing run-time text execution within a particular implementation of the present disclosure.

FIG. 6A is a diagram illustrating an embodiment of locations within the communication pathways between the user interface, the enterprise service framework, and the various business objects where core service calls can be interrupted and the various business object mockup configurations within a particular implementation of the present disclosure.

FIG. 6B is an example screenshot showing one implementation of the business object mockup configuration cockpit for use by an appropriate system, such as the system described in FIG. 1.

FIGS. 7A-B illustrate example embodiments of test data containers for use by an appropriate system, such as the system described in FIG. 1.

FIGS. 7C-E show example implementations of an embodiment of the test data container for use by an appropriate system, such as the system described in FIG. 1.

FIG. 8A is a screenshot of an embodiment of the design-time generation of a test data container for use by an appropriate system, such as the system described in FIG. 1.

FIG. 8B is a screenshot of an embodiment of a generated test data container for use by an appropriate system, such as the system described in FIG. 1.

FIGS. 9A-B are example flowcharts depicting computer implemented processes for decoupling a business object from the enterprise environment and rerouting it to a testing environment within a particular implementation of the present disclosure.

### DETAILED DESCRIPTION

This disclosure generally describes an example environment 100 for developing and testing business objects using a business object mockup framework. A business object mockup framework can include a collection of software-based tools operable to decouple service consumers from unstable service providers for testing purposes. For example, the framework may include advanced business application programming (ABAP)-based tools. The mockup framework helps establish a stable simulation environment that enables testing service consumers independently from the implementation state of the invoked service providers. Generally, the mockup framework can simulate the responses of the invoked business objects without applying their original services. Specifically, the mockup test framework can simulate the behavior of various business objects, allowing the decoupling of development, correction, and testing of intrinsic business object functionality from underlying service providers. In addition, the mockup functionality can be configured to provide a predefined set of test data, which facilitates repeated execution of tests based on the same initial state of data in other test systems. As such, the business object mockup framework can often enable testing of functionality at an early point in time.

In order to speed up the development of business objects and to quickly narrow down analyses of root causes for errors, it becomes advantageous to break up the strong dependencies between the various business objects and their consumers. As such, the present disclosure is directed to decoupling business objects from their dependencies. This allows the focus to be on more granular implementation parts of the business process, which can be developed and made to stabilize different parts of the solution in parallel. At best, granular functions are thoroughly checked and there is only limited effort for running real integration tests before software production.

Besides decoupling consumers from unstable service provider functionality, the system is configured to provide predefined test data that the service consumers can rely on when running tests, allowing the tests to be run in a stable environment and delivering reproducible results. At present, a considerable amount of time is spent in setting up test environments (i.e., bringing business objects into a defined state) as a precondition for test execution since the consistency and availability of test data cannot always be guaranteed throughout the entire system landscape. This holds true even for Common Test Data Framework (CTDF) data, which may become corrupted or may not be suitable for the individual case.

The mockup framework can be widely applicable or compatible. For example, business objects that can be simulated may include transformed business objects, standard business objects, projection objects, (enhanced) controller objects, and dependent objects. The mockup framework can be designed such that the business objects are simulated without the need for adjusting the implementation of these objects. In other words, the simulation environment can be independent of either the calling service consumer or the called service provider; the productive coding would not need to contain any test specific implementation parts. Instead, the mockup framework redirects the respective calls and provides a proper response for the related requests, perhaps based on its settings or intelligence. This way, the simulation can be configured flexibly and can be enhanced for each individual test. In other words, which business object should be mocked and how the simulation should look are configured on the business object level within the mockup framework.

In this disclosure, techniques and apparatuses are described for decoupling business objects from original service providers and rerouting them to mockup service providers to provide a stable testing and development environment. These techniques and apparatuses offer the ability to create stable testing environments and perform consistent tests quickly and with minimal maintenance and implementation effort.

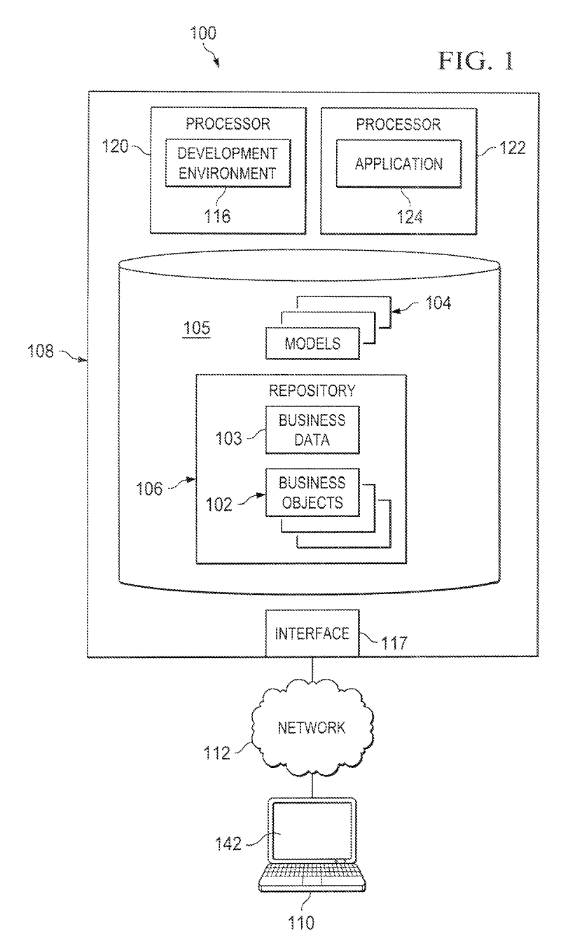

Turning to the illustrated example, FIG. 1 depicts business environment 100, which is typically a distributed client/server system that spans one or more networks such as network 112. Moreover, the processes or activities of the hosted solution may be distributed among these entities and their respective components. In some embodiments, environment 100 may be in a dedicated enterprise environment—across a local area network or subnet—or any other suitable environment without departing from the scope of this disclosure.

Business environment 100 can include or is communicably coupled with server 108 and one or more users 110, at least some of which communicate across network 112. Client 110 can be any suitable entity, for example, any computing device operable to connect or communicate with server 108 or network 112 using any communication link. At a high level, each client 110 includes or executes at least GUI 142 and, in some cases, an agent, and comprises an electronic computing device operable to receive, transmit, process and store any appropriate data associated with environment 100. It will be understood that there may be any number of clients 110 communicably coupled to server 108. Further, “client 110,” “developer,” and “user” may be used interchangeably as appropriate without departing from the scope of this disclosure. Moreover, for ease of illustration, each client 110 is described in terms of being used by one user. But this disclosure contemplates that many users may use one computer or that one user may use multiple computers. As used in this disclosure, client 110 is intended to encompass a personal computer, touch screen terminal, workstation, network computer, kiosk, wireless data port, smart phone, personal data assistant (PDA), one or more processors within these or other devices, or any other suitable processing device. For example, client 110 may be a PDA operable to wirelessly connect with external or unsecured network. In another example, client 110 may comprise a laptop that includes an input device, such as a keypad, touch screen, mouse, or other device that can accept information, and an output device that conveys information associated with the operation of server 108 or clients 110, including digital data, visual information, or GUI 142. Both the input device and output device may include fixed or removable storage media such as a magnetic computer disk, CD-ROM, or other suitable media to both receive input from and provide output to users of clients 110 through the display, namely, the client portion of GUI or application interface 142.

GUI 142 comprises a graphical user interface operable to allow the user of client 110 to interface with at least a portion of environment 100 for any suitable purpose, such as viewing business data 103. Generally, GUI 142 provides the particular user with an efficient and user-friendly presentation of data provided by or communicated within environment 100. More specifically, GUI 142 can include a mockup cockpit that presents views of configuration information of simulated business object instances. The mockup cockpit can be connected with the development environment 116 such that the mockup cockpit and/or the development environment 116 can access business object data in repository 106. The mockup cockpit can allow a user to freely choose graphical objects that can represent one or more development objects, or no development objects at all. Accordingly, GUI 142 may comprise a plurality of customizable frames or views having interactive fields, pull-down lists, and buttons operated by the user. GUI 142 may also present a plurality of portals or dashboards. For example, GUI 142 may display a portal that allows developers or information managers to view, create, and manage business objects 102 or business data 103. GUI 142 is often configurable, supporting a combination of tables and graphs (bar, line, pie, status dials, etc.) and is able to build real-time dashboards. It should be understood that the term “graphical user interface” may be used in the singular or in the plural to describe one or more graphical user interfaces and each of the displays of a particular graphical user interface. Indeed, reference to GUI 142 may indicate a reference to the front-end or a component of any application or software, as well as the particular interface accessible via client 110, as appropriate, without departing from the scope of this disclosure. Therefore, GUI 142 contemplates any graphical user interface, such as a generic web browser or touch screen, that processes information in environment 100 and efficiently presents the results to the user. Server 108 can accept data from client 110 via the web browser (e.g., Microsoft Internet Explorer or Mozilla Firefox) and return the appropriate HTML or XML responses to the browser using network 112.

Environment 100 can include a server 108 that comprises an electronic computing device operable to receive, transmit, process, and store data associated with environment 100. For example, server 108 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1 provides merely one example of computers that may be used with the disclosure. Each computer is generally intended to encompass any suitable processing device. For example, although FIG. 1 illustrates one server 108 that may be used with the disclosure, environment 100 can be implemented using computers other than servers, as well as a server pool. Indeed, server 108 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Server 108 may be adapted to execute any operating system including Linux, UNIX, Windows Server, or any other suitable operating system. According to one embodiment, server 108 may also include or be communicably coupled with a web server and/or a mail server.

Illustrated server 108 includes example processor 120. Although FIG. 1 illustrates a single processor 120 in server 108, two or more processors may be used according to particular needs, desires, or particular embodiments of environment 100. Each processor 120 may be a central processing unit (CPU), a blade, an application specific integrated circuit (ASIC), or a field-programmable gate array (FPGA). The processor 120 may execute instructions and manipulate data to perform the operations of server 108, often using software. Regardless of the particular implementation, “software” may include computer-readable instructions, firmware, wired or programmed hardware, or any combination thereof on tangible medium as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

In the illustrated embodiment, processor 120 executes development tool (or environment) 116 and business application 124. At a high level, the development environment 116 and application 124 are operable to receive and/or process requests from developers and/or users and present at least a subset of the results to the particular user via an interface.

In some instances, the development environment 116 may be used to develop (create, modify, or analyze) an application or a business object using models 104 and data 106 stored in memory 105. In general, these models can specify the types of development objects or components that can be used to build applications, such as the business object 102, as well as the relationships that can be used to connect those components. The development environment 116 may be tightly integrated with the business object mockup framework such that additions and modifications to the application 124 may be traced throughout development to analyze the various business processes executed within the environment 100. The development environment 116 may be an integrated environment for the development of J2EE-based, multi-tiered business applications. It may provide an open and extensible development environment using Java and Web services. Tool sets may be represented as perspectives that control the editors and views displayed, thereby allowing developers to switch quickly between perspectives to work on different tasks. Some example perspectives may include (i) the J2EE perspective (can support the development and deployment of J2EE technologies such as Java Server Pages, servlets, and EJBs); (ii) the web services perspective (can combine tools to define, discover, and test Web services); (iii) the persistence perspective (can support the creation and definition of database objects, such as tables and indexes, through the use of the Java dictionary, editors, and standards such as SQLJ or Java data objects); (iv) the debugging perspective (can support testing of Java applications by checking metrics, conventions, authorizations, and language restrictions); and/or (v) the Java development infrastructure perspective (can provide tools for organizing, tracking, and synchronizing the work of large groups of developers). The developer infrastructure manages source code, incrementally builds new versions, and deploys applications on the right server at the right time.

This framework can be injected or embedded, whether hard-coded or utilizing dynamic linking, into business application 124 using development environment 116. Within example development environment 116, an application can be developed (created or modified) using coding or modeling systems. Developer 110 may use environment 116 to draft source code, compile various files for applications, libraries, and such, modify or inject frameworks, or other software development. In general, models can specify the types of development objects or components that can be used to build applications, as well as the relationships that can be used to connect those components. In a given modeled architecture, development objects can be organized by any combination of relationships, including hierarchical relationships, grouping relationships, and the like. In an object-oriented architecture, for example, a defined application can include a combination of various data objects and resources (i.e., development objects). In that example, relationships among the development objects can include a relationship indicating that one data object inherits characteristics from another data object. Applications built using the model-view-controller (MVC) architecture typically include three different types of components—models, which store data such as application data; views, which display information from one or more models; and controllers, which can relate views to models, for example, by receiving events (e.g., events raised by user interaction with one or more views) and invoking corresponding changes in one or more models. When changes occur in a model, the model can update its views. Data binding can be used for data transport between a view and its associated model or controller. For example, a table view (or a table including cells that are organized in rows and columns) can be bound to a corresponding table in a model or controller. Such a binding indicates that the table is to serve as the data source for the table view and, consequently, that the table view is to display data from the table. Continuing with this example, the table view can be replaced by another view, such as a graph view. If the graph view is bound to the same table, the graph view can display the data from the table without requiring any changes to the model or controller. In the MVC architecture, development objects can include models, views, controllers, and components that make up the models, views, and controllers. For example, application data in a model can be an example of a component that is a development object.

Server 108 may also include or reference a local, distributed, or hosted business application 124. At a high level, business application 124 is any application, program, module, process, or other software that may access, retrieve, modify, delete, or otherwise manage some information of the business object repository 106 in memory 105. Specifically, business application 124 may access the business object repository 106 to retrieve or modify business data 103 stored within specific business objects 102 as requested by a user and/or another application. In one embodiment, business object repository 106 may be referenced by or communicably coupled with applications executing on or presented to client 110. In some embodiments, the business object repository 104 may be searchable, such as by requests 150 from clients 110 via the network 112. Distinct business objects 102, as well as multiple instances of a single business object 102, may be searched to allow the user 110 and/or application 124 to find a business object 102 type or a specific instance thereof on demand.

Business application 124 may be considered business software or solution that is capable of interacting or integrating with business object repository 106 located, for example, in memory 105 to provide access to data for personal or business use. An example business application 124 may be a computer application for performing any suitable business process by implementing or executing a plurality of steps. One example of a business application 124 is an application that may provide interconnectivity with one or more business object repositories 106 containing product development information such that records may be dispersed among a plurality of business objects 102. As a result, business application 124 may provide a method of accessing requested data and presenting it to the user and/or application such that the user and/or application are provided information through a GUI 142 in a centralized manner. Business application 124 may also provide the user with a computer implementable method of implementing a centralized source for agreements on one or more solutions identified by a solution provider.

More specifically, business application 124 may be a composite application, or an application built on other applications, that includes an object access layer (OAL) and a service layer. In this example, application 124 may execute or provide a number of application services, such as CRM systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 124 to orchestrate a business process in synchronization with other existing processes (e.g., native processes of enterprise base systems) and leverage existing investments in the IT platform. Further, composite application 124 may run on a heterogeneous IT platform. In doing so, composite application 124 may be cross-functional in that it may drive business processes across different applications, technologies, and organizations. Accordingly, composite application 124 may drive end-to-end business processes across heterogeneous systems or sub-systems. Application 124 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 124, it may instead be a standalone or (relatively) simple software program. Regardless, application 124 may also perform processing automatically, which may indicate that the appropriate processing is substantially performed by at least one component of system 100. It should be understood that this disclosure further contemplates any suitable administrator or other user interaction with application 124 or other components of system 100 without departing from its original scope. Finally, it will be understood that system 100 may utilize or be coupled with various instances of business applications 124. For example, client 110 may run a first business application 124 that is communicably coupled with a second business application 124. Each business application 124 may represent different solutions, versions, or modules available from one or a plurality of software providers or developed in-house.

For example, portions of the composite application may be implemented as Enterprise Java Beans (EJBs) or design-time components may have the ability to generate run-time implementations into different platforms, such as J2EE (Java 2 Platform, Enterprise Edition), ABAP objects, or Microsoft's .NET. Further, while illustrated as internal to server 108, one or more processes associated with application 124 may be stored, referenced, or executed remotely. For example, a portion of application 124 may be a web service that is remotely called, while another portion of application 124 may be an interface object bundled for processing at remote client 110. Moreover, application 124 may be a child or sub-module of another software module or enterprise application (not illustrated) without departing from the scope of this disclosure. Indeed, application 124 may be a hosted solution that allows multiple parties in different portions of the process to perform the respective processing. For example, client 110 may access application 124, once developed, on server 108 or even as a hosted application located over network 112 without departing from the scope of this disclosure. In another example, portions of software application 124 may be developed by the developer working directly at server 108, as well as remotely at client 110. It will be understood that while these applications are shown as a single multi-tasked module that implements the various features and functionality through various objects, methods, or other processes, each may instead be a distributed application with multiple sub-modules. Further, while illustrated as internal to server 108, one or more processes associated with these applications may be stored, referenced, or executed remotely. Moreover, each of these software applications may be a child or sub-module of another software module or enterprise application (not illustrated) without departing from the scope of this disclosure.

Business objects 102 are elements for information storage in object-oriented computing systems. An “object” is a software bundle of variables (e.g., data) and related methods (e.g., business logic). For example, in object-oriented programming, an object is a concrete realization (i.e., an instance) of a class that consists of data and the operations associated with that data. Software components or entities, such as service entities and Web service entities, generally take the form of objects, in some binary or textual form, and adhere to one or more interface description languages (IDL), so that the components or entities may exist autonomously from other components or entities in a computer system. The phrase “business object” refers to a software bundle of variables and related methods that can be used to encapsulate business logic that describes a business process or task. For example, a client can call the API of a service entity provider through a communication mechanism, such as the Internet or intranet. The API, when called, instantiates business objects, such as a catalog service entity provider for listing products from a catalog or a purchasing service entity provider for allowing the purchase of a product.

Business logic encapsulated in a business object may be decoupled from business scenario-specific requirements. The business logic encapsulation may be governed by business-driven functionality requirements, leading to a normalized approach. Typically, the encapsulated business logic is designed independent of user interface requirements. The business logic encapsulation is instead designed to provide a stable interface and maximum reusability. In contrast, a user interface requirement is typically governed by the user's perspective in a specific scenario. Thus, in different user interface scenarios, user interface requirements may require different parts of a business object or even parts from separate business objects. For example, a user interface specific scenario for displaying items in a sales order may rely on both a sales order business object for accessing the sales order and a product information business object for retrieving product information related to the items in the sales order.

Business objects 102 can describe the characteristics of an item using a series of data fields that, for example, can correspond to described characteristics. Typically, a programmer will predefine standard object classes, referred to in the present specification as object types, that are hard-coded into a set of machine-readable instructions for performing operations. Object types are blueprints for describing individual objects using a defined set of class attributes (or properties). Instantiated objects that are members of such standard object types can be applied in a variety of different data processing activities by users, for example, customers who are largely unaware of the structure of the standard object types. Put another way, the data objects 102 are generally logical structures that can be modeled and then instantiated upon deployment to store particular data. Business objects may be a particular form of data object that a developer can utilize or reference in the front-end of any business or other modeled application.

Business objects 102 may represent organized data relating to some project or endeavor, which may or may not be linked, with each object having one or more states related to the object. Each of the states, in turn, may be associated with data that pertains to various modifiable parameters of the individual states of the object. One type of data modeling that includes multiple objects with each having multiple states, and each state having multiple instances of changes to the state's modifiable parameters is the business object model. The overall structure of a business object model ensures the consistency of the interfaces that are derived from the business object model. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

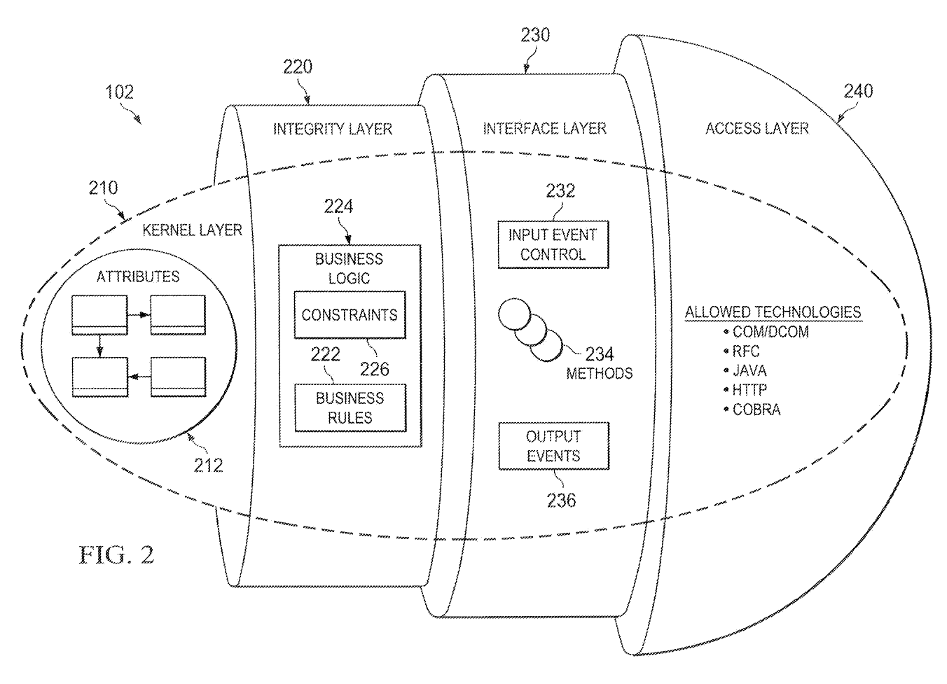

FIG. 2 illustrates the structure of a generic business object 102 in environment 100. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is thus a capsule with an internal hierarchical structure, behavior offered by its operations, and integrity constraints. Business objects are generally semantically disjointed, i.e., the same business information is represented once. In some embodiments, the business objects are arranged in an ordering framework such that they can be arranged according to their existence dependency to each other. For example, in a modeling environment, the customizing elements might be arranged on the left side of the business object model, the strategic elements might be arranged in the center of the business object model, and the operative elements might be arranged on the right side of the business object model. Similarly, the business objects can be arranged in this model from the top to the bottom based on defined order of the business areas, e.g., finance could be arranged at the top of the business object model with customer relationship management (CRM) below finance and supplier relationship management (SRM) below CRM. To help ensure the consistency of interfaces, the business object model may be built using standardized data types as well as packages to group related elements together, and package templates and entity templates to specify the arrangement of packages and entities within the structure.

A business object may be defined such that it contains multiple layers, such as in the example business object 102 of FIG. 2. The example business object 102 contains four layers: the kernel layer 210, the integrity layer 220, the interface layer 230, and the access layer 240. The innermost layer of the example business object is the kernel layer 210. The kernel layer 210 represents the business object's 102 inherent data, containing various attributes 212 of the defined business object. The second layer represents the integrity layer 220. In the example business object 102, the integrity layer 220 contains the business logic 224 of the object. Such logic may include business rules 222 for consistent embedding in the environment 100 and the constraints 226 regarding the values and domains that apply to the business object 102. Business logic 224 may comprise statements that define or constrain some aspect of the business, such that they are intended to assert business structure or to control or influence the behavior of the business entity. It may pertain to the facts recorded on data and constraints on changes to that data. In effect, business logic 224 may determine what data may, or may not, be recorded in business object 102a. The third layer, the interface layer 230, may supply the valid options for accessing the business object 102 and describe the implementation, structure, and interface of the business object to the outside world. To do so, the interface layer 230 may contain methods 234, input event controls 232, and output events 236. The fourth and outermost layer of the business object 102 in FIG. 2 is the access layer 240. The access layer 240 defines the technologies that may be used for external access to the business object's 102 data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects 102 of this embodiment may implement standard object-oriented technologies such as encapsulation, inheritance, and/or polymorphism.

Returning to FIG. 1, Server 108 often includes local memory 105. Memory 105 may include any memory or database module and may take the form of volatile or non-volatile memory including, without limitation, magnetic media, optical media, random access memory (RAM), read-only memory (ROM), removable media, or any other suitable local or remote memory component. Illustrated memory 105 includes one or more business objects 102 and one or more business data elements 103 (it should be understood that business data 103 can also act as test data in a testing or development environment). But memory 105 may also include any other appropriate data such as HTML files or templates, data classes or object interfaces, software applications or sub-systems, and others (whether illustrated or not). For example, memory 105 may include pointers or other references to business objects 102 that were published to a location remote from server 108. Some or all of the business objects 102 and business data 103 may be stored or referenced in a local or remote development or metamodel repository 106 found in memory 105. This repository 106 may include parameters, pointers, variables, algorithms, instructions, rules, files, links, or other data for easily providing information associated with or to facilitate modeling of the particular object. More specifically, each repository may be formatted, stored, or defined as various data structures in eXtensible Markup Language (XML) documents, text files, Virtual Storage Access Method (VSAM) files, flat files, Btrieve files, comma-separated-value (CSV) files, internal variables, one or more libraries, or any other format capable of storing or presenting all or a portion of the interface, process, data, and other models or modeling domains. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

Server 108 may also include interface 117 for communicating with other computer systems, such as clients 110, over network 112 in a client-server or other distributed environment. In certain embodiments, server 108 receives data from internal or external senders through interface 117 for storage in memory 105 and/or processing by processor 120. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals. Interface 117 may allow communications across network 112 via a virtual private network (VPN), SSH (Secure Shell) tunnel, or other secure network connection.

Network 112 facilitates wireless or wireline communication between computer server 108 and any other local or remote computer, such as clients 110. Network 112 may be all or a portion of an enterprise or secured network. In another example, network 112 may be a VPN merely between server 108 and client 110 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 108 and at least one client 110. In other words, network 112 encompasses any internal or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain local or remote clients 110. Network connections may include, alone or in any suitable combination, a telephony-based network, a local area network (LAN), a wide area network (WAN), a dedicated intranet, wireless LAN, the Internet, a wireless network, a bus, or any other communication mechanisms. Further, any suitable combination of wired and/or wireless components and systems may be used to provide network connections. Moreover, network connections may be embodied using bi-directional, unidirectional, or direct communication links. Further, network connections may implement protocols, such as transmission control protocol/internet protocol (TCP/IP), hyper text transfer protocol (HTTP), file transfer protocol (FTP), simple object access protocol (SOAP), common object request broker architecture (CORBA), remote procedure call (RPC), and the like.

While FIG. 1 is described as containing or being associated with a plurality of components, not all components illustrated within the illustrated implementation of FIG. 1 may be necessary in each alternative implementation of the present disclosure. Additionally, one or more of the components described herein may be located external to environment 100, while in other instances, certain components may be included within or as a portion of one or more of the other described components, as well as other components not described. Further, certain components illustrated in FIG. 1 may be combined with other components, as well as used for alternative or additional purposes in addition to those purposes described herein.

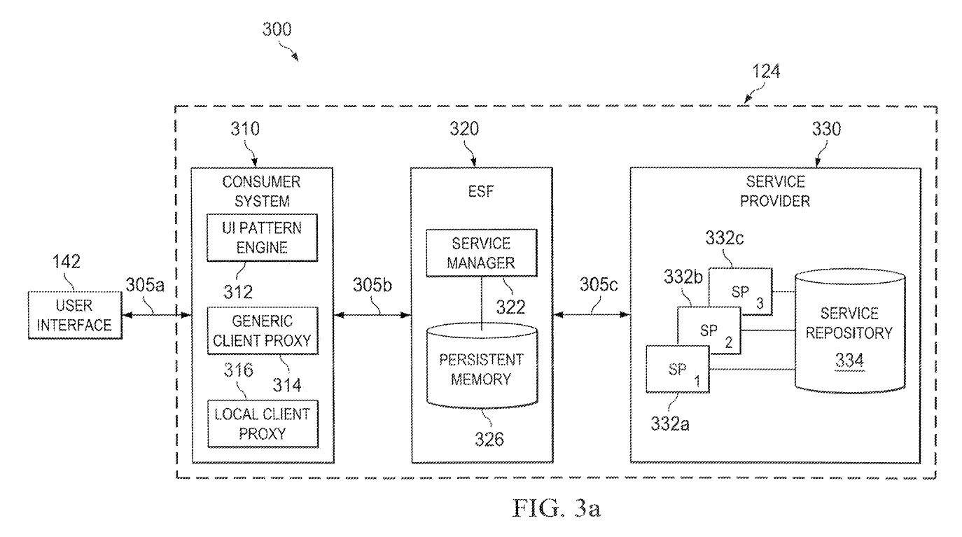

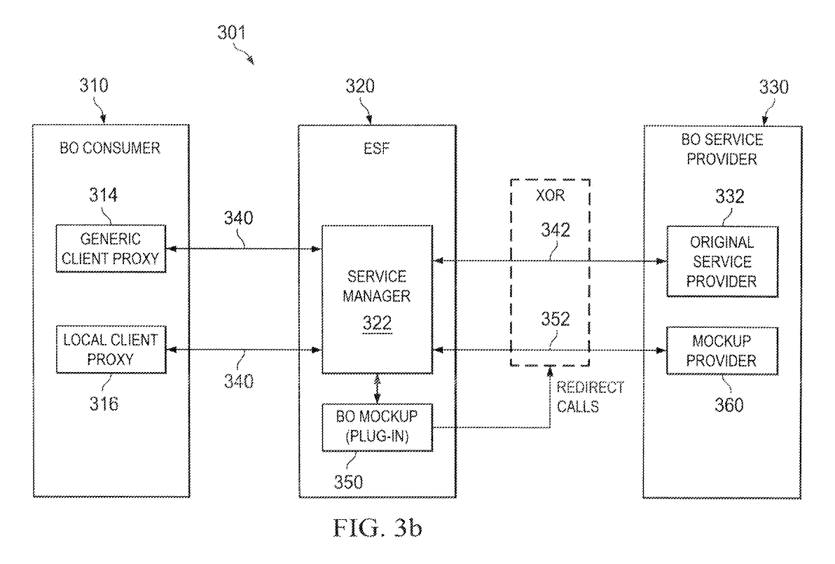

FIG. 3 illustrates a block diagram of environment 300 including business enterprise application 124. This example application 124 can communicate with a user 110 through a GUI 142, network connections 305a-c, a consumer system 310, a service framework 322, and a service provider 330. Consumer system 310 may further include user interface pattern engine 312, a generic client proxy (GCP) 314, and a local client proxy (LCP) 316. Service framework 320 can include a service manager 322 for routing calls between the consumer (or consumer business objects) and the service provider (or service provide business objects). Service provider 330 further includes service providers business objects 332a-c and a service repository 334.

GUI 142 may provide content, such as visual displays, to user 110. Moreover, user interface 142 may include a browser configured on consumer system for interacting with applications, such as service providers. For example, the browser of user interface 114 may connect, at runtime, to user interface pattern engine 312, generic client proxy 214, and local client proxy 316 through network connections and service manager to view and interact with content from service providers. User 110 may request an instance of a business object at one of service providers 332a-c, for example a purchase order form through user interface 142. User interface 142 may then send the configuration information of the purchase order form to consumer system for configuring the purchase order form. For example, the configuration information configures the purchase form by defining the display such that the content from a service provider 332 is provided to the configured order form.

In one embodiment consistent with aspects of the present invention, application 124 may be implemented with an enterprise services framework (ESF) 320. In a service framework, such as an ESF that includes service entities, a client 110 can call a service entity from a service entity provider through an Application Programming Interface (API). As used herein, the term service framework refers to a defined support structure in which software systems and applications, such as Web services, can be developed, organized, compiled, deployed, customized, run, and/or executed. A service framework may include computer hardware, computer networks, user interfaces, support programs, code libraries, code repositories, scripting language, or other components to help develop and glue together the different components of one or more software systems or applications. The service entity provider allows the instantiation of business objects in response to the API call. As used herein, the term “instantiate” means, in an object oriented programming environment, an object of a particular class, and, more generally, includes deploying, customizing, running and/or executing an application.

ESF 320 allows service entities such as Web services, software applications, software components, and software modules, to be aggregated to form composite business-level applications. Although FIG. 3A is described with respect to an enterprise service architecture, application 124 may utilize any other framework or software architectural environment. For example, consumer system 310 may be implemented as a client, and service provider 330 may be implemented as a server in a client-server architectural environment. Service manager 322 may be implemented at either the client or the server.

Network connections 305a-c may be embodied using bidirectional, unidirectional, or direct communication links. Further, network connections may implement protocols, such as transmission control protocol/internet protocol (TCP/IP), hyper text transfer protocol (HTTP), file transfer protocol (FTP), simple object access protocol (SOAP), common object request broker architecture (CORBA), remote procedure call (RPC), and the like.

User interface pattern engine 312 may receive configuration information of the requested user interface design, such as configuration information of a purchase order form, from user interface 142. User interface 142 may then send the configuration information of the purchase order form to consumer system 310 for configuring the purchase order form. At runtime, user interface pattern engine 312 may interpret the configuration information, and transform the configuration information into an API call to service provider 330 through generic client proxy 314 or local client proxy 316 and service manager 322. Enterprise service framework 320 should allow a client to call a business object 102 (either on the consumer side or at the service provider), which is performed using the generic client proxy 314. In addition, the called business object should be able to recursively call itself or call another business object, which is performed using the local client proxy 316.

Generic client proxy 314 may include an API that is accessible to user interface 142. When generic client proxy 314 is instantiated, it 142 may provide an interface, such as a RPC or a SOAP interface, to service manager 322 through network connection 305b. Generic client proxy 314 may be implemented to control the functionality available to user interface 142 by providing a well-defined interface to service manager 322. For example, service manager 322 may include a variety of functions, but user interface 142 may be allowed access only to a subset of those functions. Moreover, generic client proxy 314 may buffer requests and/or responses between user interface 142 and service manager 322.

Generic client proxy 314 may call service manager 322. Generic client proxy may include a message handler for handling messages to and from service manager 322; a change handler for handling changes affecting service providers 332a-c (e.g., changes that occur when user 110 interacts with user interface 142, such as a button click, that affects a service provider 330 or the corresponding business objects 332a-c); a controller for controlling dynamic properties of the instance (e.g., making data associated with a business object read-only, changeable, mandatory, invisible, and the like); and a stack for storing changes associated with the change handler in a last in, first out manner.

In some implementations, a business object may call other business objects. Local client proxy 316 is the communication found whenever a business object calls another business object, an agent calls a business object, or when a unit test calls a business object. Local client proxy 316 may also provide to service manager 322 change notification messages concerning changes to service providers 332a-c, access to metadata associated with service providers 332a-c, and/or provide exception handling when a business object recursively calls itself. Local client proxy 316 can provide an API, which is local to the server. As such, local client proxy 316 may be used instead of generic client proxy 314, as the top-level caller of business objects. Local client proxy 316 may interface with service manager 322 in a similar way as generic client proxy 314 does, thus simplifying the API implementation at the service manager 322. Local and generic client proxy implementations and behavior are described in U.S. Pub. Nos. 2007/0061431 and 2007/0157167, which are incorporated by reference herein.

Service manager 322 may further analyze the incoming API call from generic client proxy 314, which contains the configuration information. For example, service manager 322 may instantiate one or more service provider objects 332a-c. When service provider 332a, for example, is instantiated, service provider 332a may instantiate a business object and the corresponding business object node. A business object node refers to a unit, or a component, of a business object. A business object node contain data and/or associations to other business object nodes. A business object may also support generic, mass operation-enabled read and write operations, navigation to other business object nodes via associations, queries, actions (e.g., print, create follow-on document), and access to dynamic meta data. For example, user may access user interface to request a purchase order form (the purchase form and its related methods encapsulated in a business object) from service providers, along with a component of the purchase order form (e.g., a product description in the purchase order form) corresponding to a business object node. The structure of this business object node may reflect the configuration of the requested user interface design. For example, the business object node may be used by service provider to fulfill the incoming API call from generic client proxy.

Service repository 334 stores and organizes services and the information that the services consume and produce. Service repository 334 stores and organizes information about the structure of a business object, for example, business object nodes contained in the business object and the queries, actions, and associations associated with the business object nodes. The information stored in service repository 334 may also describe if those business object nodes allow reading and/or writing. At design time, a developer (or designer) may request and receive an index of services from consumer system 310, service framework 320, and/or service provider 330. The developer may select one or more existing services from the index and retrieve the existing services from service repository 334 to help design new services and define new inter-relationships between services. At runtime, service providers 332a-c may search for information sources in service repository 334.

FIG. 3B is a block diagram illustrating application 124 of FIG. 3B implemented with the business object mockup framework, showing a mockup framework core service provider switch 352. FIG. 3B illustrates an example interaction between a consumer of a business object and a service provider. The underlying requests by the consumer can be routed via the ESF via the service manager and processed by the service provider. In the mockup framework, without knowledge of the consumer, the system can exchange the way the request is handled within the service manager. The call is delegated from the original target provider to the mockup provider.

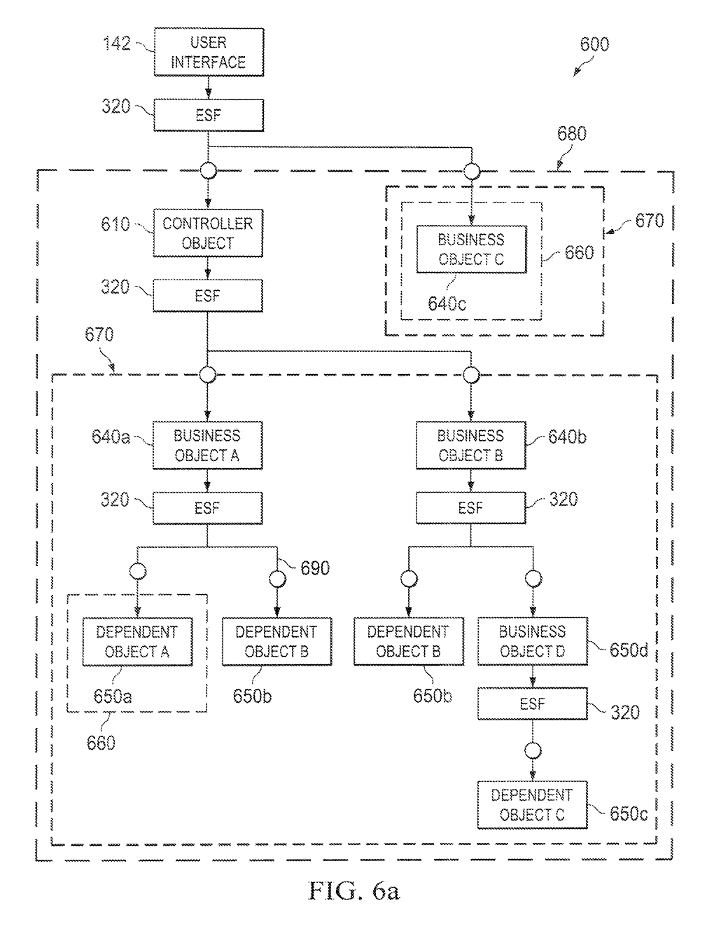

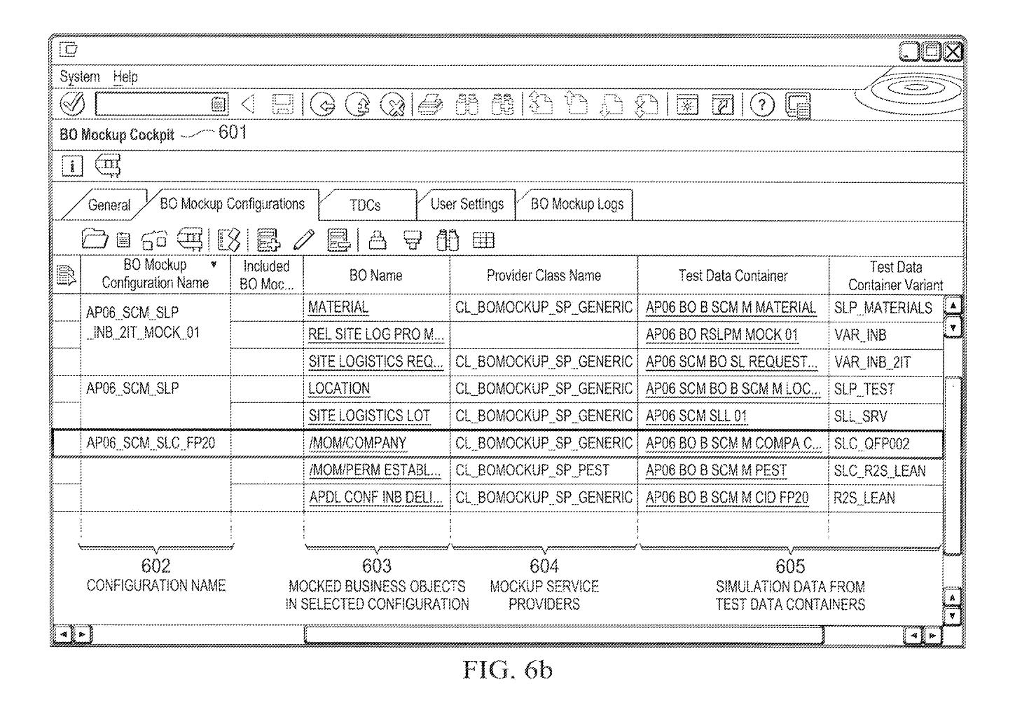

With respect to FIG. 3B, on the consumer side 310, access to and communication with the ESF 320 and provider 330 backend can be facilitated using a global client proxy 314 or local client proxy 316. The ESF 320 and service manager 322 facilitate communication and routing between the UI 142, the business objects 102 (not shown), and other objects (i.e., controller objects, see FIG. 6). The calls from the consumer side 310 can be routed to the service provider side 330 and processed at the service provider 332. The switch 350 is implemented within the ESF 320. The switch 350 enables suppression of the calls to the original service provider business objects 322 and redirection of the calls to respective test (mockup) providers 360. The business object mockup framework can implement a plug-in 350 to the ESF service manager 322 which enables it to redirect core service calls (e.g., call redirect 352). By default the plug-in 350 implementation is inactive, thus it may have no impact on performance and no risk of implementation errors endangering the standard ESF functionality. In addition, the use of a plug-in allows for implementation of the mockup framework without having to alter or augment the productive coding of the service provider. The business object mockup framework plug-in 350 can be activated and deactivated on demand (i.e., statically or dynamically for individual or all users).

As described above, the mockup framework can be a collection of ABAP-based tools that aim at decoupling service consumers (e.g., UI, business objects) from unstable service providers (e.g., business objects, dependent objects, etc.) for testing purposes. The mockup framework can establish a stable simulation environment which enables testing service consumers independently from the implementation state of the invoked business object service providers. It simulates the responses of the invoked business objects without invoking their original services. In addition the mockup functionality can be set up in a way that a predefined set of test data is supplied allowing repeated execution of tests based on the same initial state of data in all test systems. Thus the business object mockup framework ensures testing of functionality at a very early point in time.

Further, as described in more detail below, the mockup framework can include or link to a configuration part where a test environment can be defined, so a simulation of a business object or service provider can be precisely defined. It can also specify which business object to simulate. The mockup framework can also provide initial data, such as test data containers, containing information that can be used within the service provider or consumer for running the tests. Another part is the mockup provider containing different provider implementations for different purposes, such as the generic service provider, which will simulate the behavior of the original service provider. The behavior is derived from metadata stored on the repositories. Furthermore, if simulating the real provider behavior is unnecessary, but the consumer is interested in getting a response or data upon a query, a mockup provider can return data and a positive response. This is useful in a UI test, when what is requested is to navigate to another floor plan and when what is expected is to get a target instance from the backend so that the navigation can be carried out.

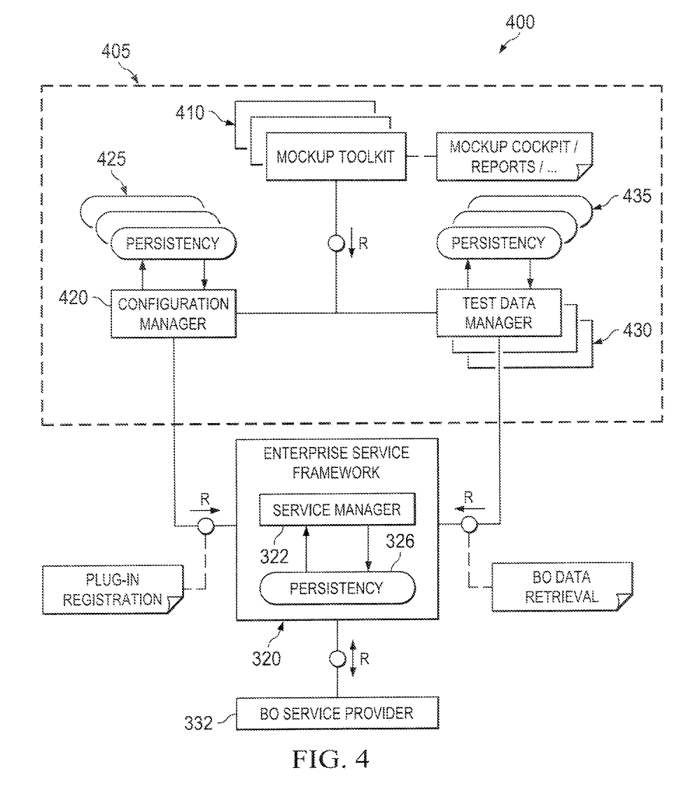

FIG. 4 is a data flow diagram illustrating the design-time test preparation process 400. In FIG. 4, the shaded portions (i.e., the ESF and its components and the business object service provider) are not considered part of the business object mockup framework. The business object mockup framework 405 can provide several design-time tools that enable developers to perform several tasks. A mockup toolkit 410 can communicate with a configuration manager 420 and a test data manager 430. The mockup toolkit 410 can include features such as the mockup configuration cockpit or reports. The configuration manager 420 can accesses plug-in registration information and mockup settings at a persistent memory 425 and can communicate with the ESF 320.

The test data manager 430 accesses memory 435 to retrieve and/or store test data. Test data can stored in database tables or can be stored using test data containers. Developers can set up a mockup configuration by defining which business object to be simulated, how the simulation should be performed, and what data should be used. In addition, the mockup environment can be registered statically or dynamically. The statically registered mockup environment, for example, can provide general activation of the business object mockup framework for a user or user group and a given mockup configuration. The design-time tools can also enable developers to easily generate business object test data from existing business object instances for convenient setup of a simulation environment. When defining or generating simulation data, existing business object instances can be used and retrieved in order to reduce implementation or development effort. The mockup plug-in can register with the ESF at several places, such as before the toolkit 410 communicates with either the configuration manager and/or the test data manager; when the configuration manager communicates with the ESF 320; when the test data manager communicates with the ESF 320; or when the business object service provider communicates with the ESF 320. Plug-in registration alerts the system components to make a determination on how or whether to route a service call to a mockup business object.

The set of tools provided allows setting up a simulation environment in a flexible and efficient way. The mockup framework can support other tests by a wide range of tools. For example, the mockup framework tools can be configured to create test data containers on basis of existing business object instances. In addition, the framework can display test data containers within business object test shell and UIs. Furthermore, the framework can be made operable to trace and replay LCP communication for error analysis. In addition, tools are provided for extracting business object instances defined in any system and for facilitating the creation of persistent data that can be used in the test environment (using reports and APIs) applications can use to access functions.

During runtime, the business object mockup functionality facilitates the simulation of the behavior of any business object service provider. Whenever core services are accessed via the ESF, the calls can be simulated. When a business object service provider is mocked, no core service call should reach the original provider. This is achieved by plugging the business object mockup functionality into the central ESF functionality. Here the mockup plug-in checks all business object service provider related calls and redirects them to configured mockup providers (e.g., generic business object service provider implementations or replay of captured communication streams) if necessary. Furthermore the mockup plug-in prevents the invocation of the original service provider.

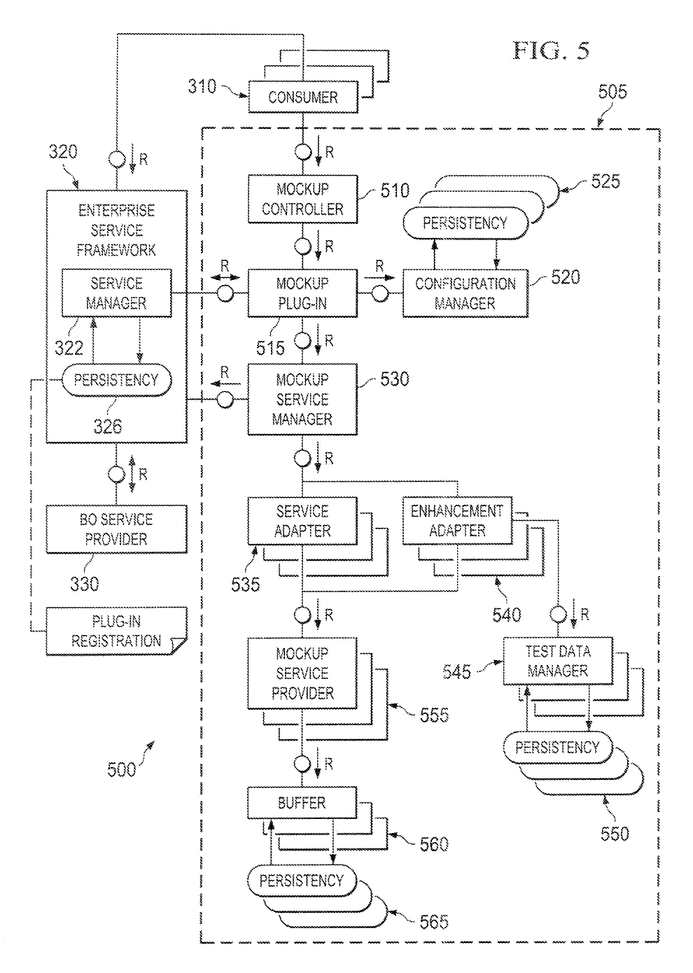

FIG. 5 is a schematic illustrating the run-time overview 500 for test execution. The environment includes a consumer 310, an ESF 320, a business object service provider 330, and the mockup framework 505. The ESF also includes a service manager 322 in communication with a repository 326. The consumer 310 can invoke a service provider 320 by making a query, such as a unit test or access to a business object service provider 330.

The mockup framework can include a business object mockup controller 510. The mockup controller 510 can be used to initialize the mockup environment 505 during setup of a test. The mockup framework 505 can implement a mockup plug-in 515 to interact with the ESF service manager 322. The plug-in 515 can be configured to retrieve the necessary configuration data and, in embodiments, registers itself at the ESF service manager 322. The plug-in 515 has a configuration manager 520 that can define which business objects should be mocked and by what means this simulation should be done. The configuration manager accesses a persistent memory 525, where plug-in registration information and mockup settings are stored.

In embodiments, the mockup framework 505 can be configured to generate mockup business objects using data and/or metadata stored in repository 525. The ESF 320 can call upon different, existing mockup service provider implementations. One example is the so-called generic service provider that will simulate the behavior of the original service provider, as long as this behavior can be derived from meta-data stored on repositories. Another provider can be used to elicit specific responses from the service provider. Whenever this provider is called, it can return data and/or positive response. This can be used in a UI test where the request is to navigate to another floor plan. In this instance, all that needs to be returned is a target instance from the back-end in order to carry out the navigation. Similarly, a service provider can be used to retrieve specific data in instances, for example, when the request is directed to checking whether information is populated correctly in a form or table. The generic providers limit implementation and maintenance efforts and implementation is always up to date. Furthermore, generic service providers are applicable for all business objects. Functionality, however, can be limited to the simulated services (i.e., business object specific functions may not be supported). The generic service providers may rely solely on the current metadata definitions, such as ESF or fast search infrastructure (FSI), that are evaluated during runtime, thus being always up to date (i.e., there would be no need to regenerate any functionality). The outcome would be to mitigate the need for using service provider implementations that may require large implementation and maintenance efforts. Furthermore, the use of test data containers can be advantageous for transporting content between systems.

The mockup service provider evaluates the request and provides a response based on its implementation. In the generic service provider embodiment, all available metadata is considered and used along with the test data that was initially passed to the mockup service provider. A generic buffer helps enable the simulation of all business object instance transitions and images. Furthermore, a generic persistency allows data to be kept for longer periods of time.

A capture-and-replay mockup service provider offers capture and replay functionality. Service calls by the consumer and the corresponding response from the service provider can be captured. For example, the calls can be buffered, converted to XML format, and persisted in a database table. During a simulation where the consumer makes a service call that has previously been made, answered, and recorded, the functionality can be replayed by feeding the former response to the previous service invocation to the consumer. The simulated business object service provider may not be involved. If the interaction pattern changes, however, the recorded information may not be valid anymore, and the data may need to be reworked. There can be the option to trace the local client proxy communication and to provide the recorded XML stream during simulation. The simulation represents the responses of the service provider for the related consumer requests. That is, from the consumer perspective, the simulation works exactly as the mocked business objects. Capturing the local client proxy communication requires a working set of business objects that are addressed by the consumer during tracing. Furthermore, any change in the choreography and content of the calls invalidates the recordings and thus requires a rework of the recorded scripts.

A handcrafted (or specifically implemented) mockup provider is also supported. The system can implement service providers specifically for each service call or test. Handcrafted (or specifically implemented) service providers can be fully flexible with optimal support in every use case. An application can decide that an existing (e.g., generic) mockup provider is not sufficient; for example, the application wants to implement other business checks and interaction checks that cannot be covered by looking at metadata in the generic mockup provider. So the application can define its own mockup provider—the handcrafted mockup provider, which is a type of service provider class defined for test purposes. The handcrafted mockup provider may be defined and implemented for a single retrieve call or modified call to provide a specific response and to check whether the service provider or consumer that calls the functionality reacts as expected with the result. Using handcrafted (or specifically implemented) mockup providers may have a high implementation effort cost, but by using them, the application can implement a simulated mockup provider for a variety of application requirements. Similar to the generic mockup provider and the capture-and-replay functionality, no alterations or additions to the productive coding are required; rather, the service call is routed to the mockup provider using a switch in the ESF. During configuration of the mockup framework, the specific mockup class can be defined.

The configuration manager 520 can be run statically or dynamically. In a statically configured framework, the mockup environment 505 is always on, and tests can be run without having to switch on the mockup environment 505 or register the mockup plug-in 515. In a dynamically configured framework, the test environment is switched on for single user and/or a single session. This can be done in a dynamic way such that after the unit test is executed and the service or the business object is later accessed, the simulation is not active. The plug-in 515 (or switch) can interpret the configuration and processes the call accordingly. In the dynamically configured embodiment, the business object mockup controller 510 initializes the mockup environment 505 during the setup of a test. The mockup plug-in 515 registers itself with, for example, the ESF 320, so that the ESF 320 can query the plug-in 515 during a service call. In the statically configured embodiment, the environment is always on, so the ESF 320 will query the plug-in 515 for a test each time a consumer 310 makes a query. If there is no mocked business object involved in the call, the plug-in 515 returns control back to the ESF service manager 322.

The mockup framework 505 can also include a mockup service manager 530 in communication with the mockup plug-in 515. The mockup service manager 530 is operable to evaluate the call and determine, based on the mockup configuration, how to handle the call. In case there is no mocked business object involved in the current call, the mockup service manager 530 returns control back to the ESF service manager 322. Otherwise, the mockup service manager 530 can parse complex service calls into granular core service calls and dispatch the request to either the original service provider 330 via the ESF 320, or to the mockup providers 555. In the latter case, the call can be directed to an appropriate adapter class of the configured mockup provider (such as the generic service provider, the capture-and-replay provider, or the handcrafted business object provider) via the service adapter 535. In other words, it is possible for applications to provide specific implementations for several parts of the business object mockup framework 505 if, for example, the generic providers are not suitable. If the call is the first call of the particular business object, the mockup provider 505 is initialized, and test data is passed to the mockup provider 555 before executing the service call. The mockup service manager can be in communication with an enhancement adapter 540. Enhancement adapter 540 allows application specific redefinitions of the standard generic mockup behavior. Enhancement adapter 540 can communicate with test data manager 545 to access database tables or test data containers to retrieve and store information to facilitate specific enhancement options for applications (e.g., for initialization of service providers).

The mockup service provider 555 can evaluate the request and provide a response based on the configuration implemented. In the case of the generic business object mockup service providers, all available metadata may be considered and used along with the test data that is initially passed to the mockup service provider 555. The mockup framework 505 can also include a buffer 560 that accesses persistent memory 565. The buffer 560 enables simulation of all business object instance transitions and images.

FIG. 6A illustrates an embodiment of the communication pathways 600 between the user interface 142, controller object 630, business objects 640a-c, and dependent objects 650a-d. Communication between objects can be facilitated via ESF 320. The dark circles (e.g., 690) lying in the communication pathway represent locations at which core service calls can be diverted to a mockup provider. As shown in FIG. 6, the mockup environment can be configured in different ways via a configuration utility. For example, the environment can be configured per business object list 670. This configuration allows exclusion of dedicated unstable business objects from testing. Furthermore, the mockup environment can be configured per business object type 660 (e.g., for all non-controller objects). This configuration enables testing of UI interaction with underlying controller objects independently from business objects that are accessed by the enhanced controller object. The environment can also be configured for all business objects 680. This configuration enables testing of user interfaces independently from business object and controller object implementation. FIG. 6B is an example screenshot of the business object mockup cockpit interface illustrating a design-time business mockup configuration.

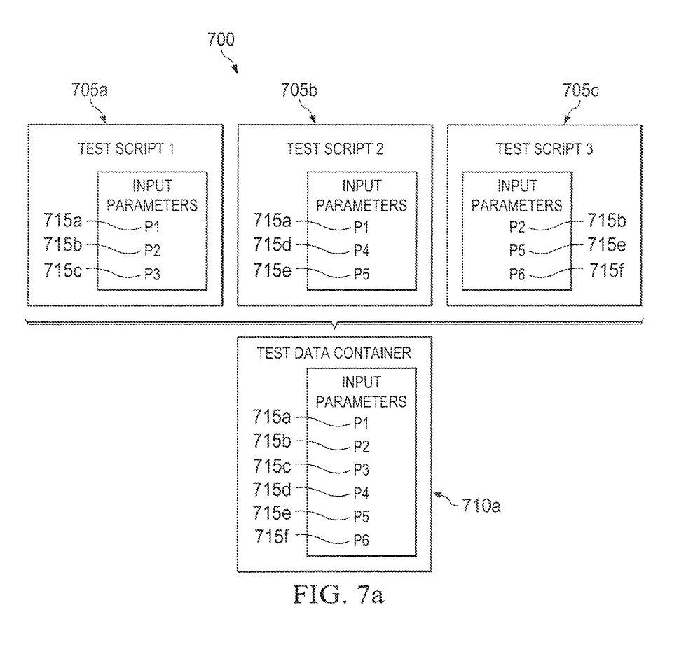

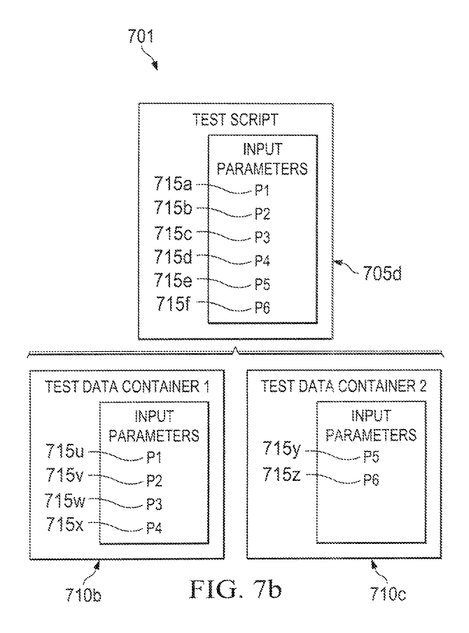

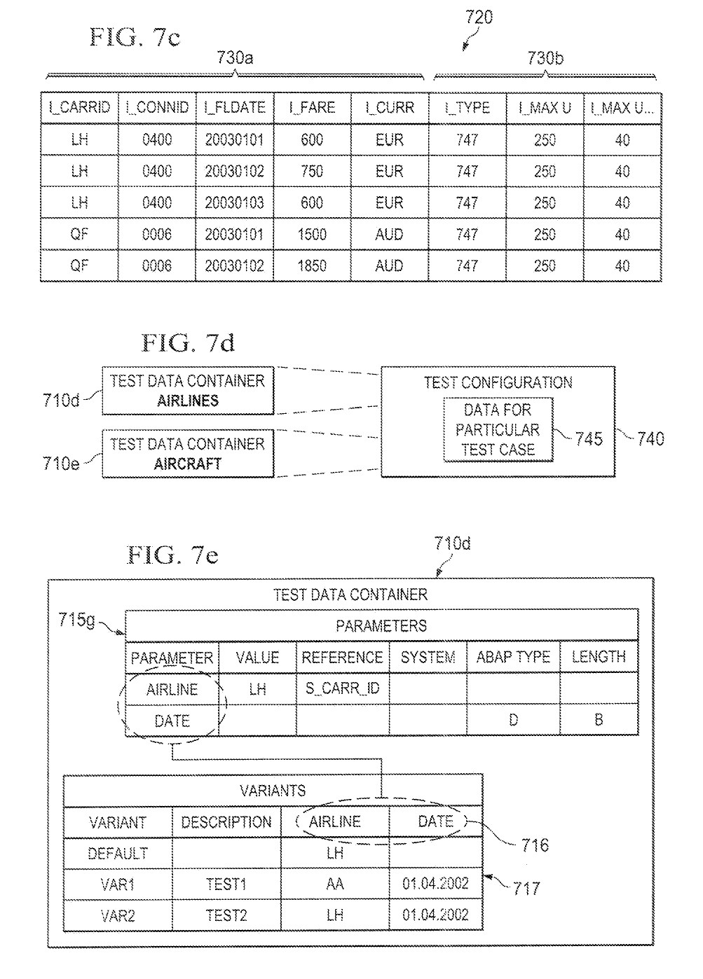

Apart from offering the general switch option for redirecting core service calls, the business object mockup framework provides different tools which enable developers to easily and fast set up a mockup environment. For example, the mockup framework provides tools to facilitate the generation of test data containers from existing business object instances or generic service providers. FIG. 7A illustrates an embodiment of a test data container 700. The bulk of the test data can be stored separate from the test scripts 705a-c in test data containers 710a. This allows for reusability and maintainability of the test data. Usually, a test data container 710a and a test script (e.g., 705a-c) are brought together in test configuration to create an executable test case. The parameters 715a-f in, for example, test data container 710a are maintained independently from any of test scripts 705a-c. Thus, multiple scripts 705a-c can point to the same test data container 710a, as shown in FIG. 7A. A maintenance system for the test data container 710a and a different target system for each parameter 715a-f can be specified. The most simple use of a test data container is to create a separate one for each test script. This configuration, however, may not provide many of the advantages of reuse. An effective way to manage test data 715a-f is to create a single test data container 710a for a whole application or sub-application (as shown in FIG. 7A). By storing all of the test data 715a-f in one container, it can be easier to keep the data consistent.

In contrast to using a single test data container for all parameters, you can distribute the parameters over several test data containers (shown in FIG. 7B). For example, for a large number of scripts (such as test script 705d), each with many parameters 715u-z, using a single test data container may no longer be a practical option. In this case, you could split the parameters into logical groups, each in its own test data container 710b and 710c.

This later approach can be illustrated by the example of FIG. 7C, where the raw data for a transaction based on the flight data model is shown in the table 720. Much of the data falls into two logical groups (i.e., airline 730a and aircraft 730b), and many of the fields have identical values. By separating the airline data 730a and the aircraft data 730b into different test data containers, as shown in FIG. 7D, they can then be conveniently reused when a test script calls for data of the appropriate sort. For example, airline data 730a can be contained in test data container 710d; and aircraft data 730b can be contained in test data container 710e. The test containers can be used in test configuration 740 as data for a particular test 745. Additionally, by condensing the data so that particular combinations occur only once, (e.g., LH 400) the combination only would be changed in one place to affect all tests that reference it. In case of the current disclosure, it is possible that the scripts 705a-d are not used. Instead, the test data containers 710 may be used directly within the mockup framework.

The test data container has mandatory attributes (e.g., title, package, person responsible, and application component) as well as attributes containing administrative information. As shown in FIG. 7E, test data container 710d consists of parameters 715g and variants 716. The parameters 715g describe the interface of the test data container 710d, and the variants 716 store the data. The parameters 715g can be defined in a similar way that the parameters 715a-f in test script 705 are defined in example FIG. 7A-B. If a parameter 715g is structured, display and edit functions can be facilitated in the structure editor. Each variant 716 contains a field for each parameter 715g.

Different versions of test data containers can be created. In this way, the same test data container can be used, and, for example, different parameter references for various releases or for various business functions can be maintained. There is only one object for each test data container, irrespective of how many versions exist. In other words, there is only one object in the object directory. The following table summarizes what must be, or need not be, retained across versions. The following data is the same in all versions of a test data container: parameter names; variant names; and other attributes. The following data for each individual version can be specified: the names of parameter references; the values in variants; the links to external test data; versioning data; and other attributes.

The test data editor may be used to create and maintain test data containers. The parameters in a test data container are maintained independently from any test script. A maintenance system for the test data container can be specified; a different target system for each parameter can also be specified. Test data containers can be downloaded as XML files. Variants containing different parameter values can be created.

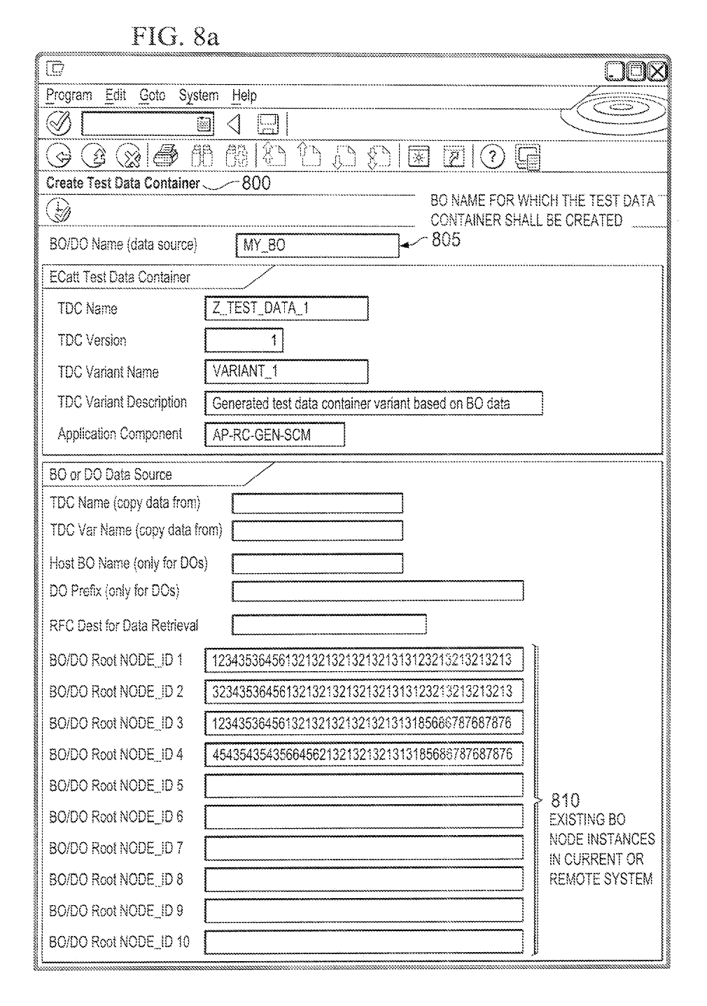

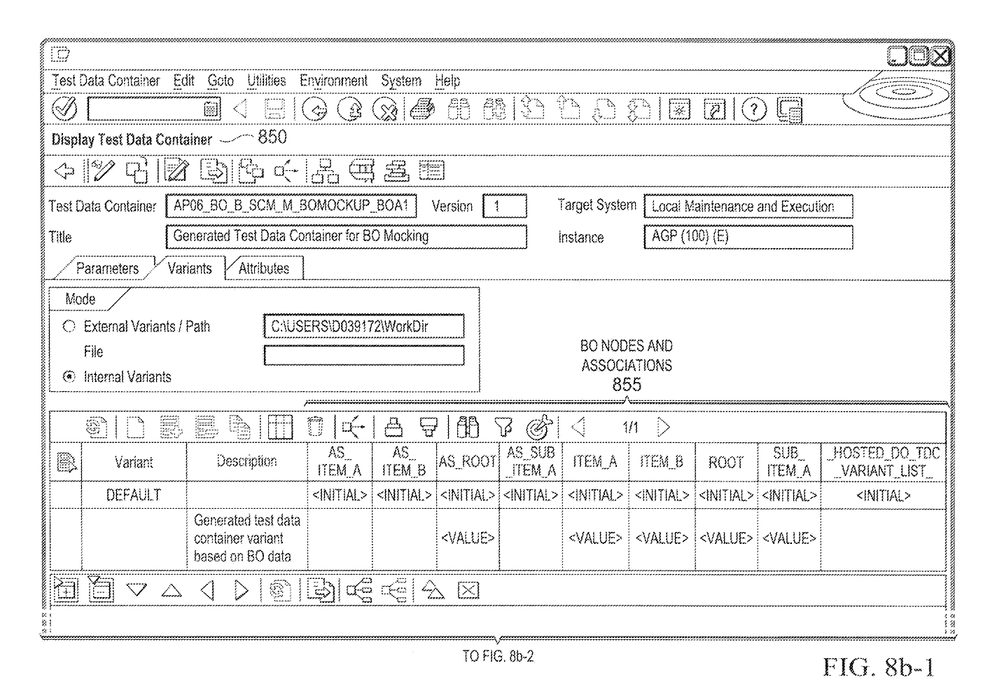

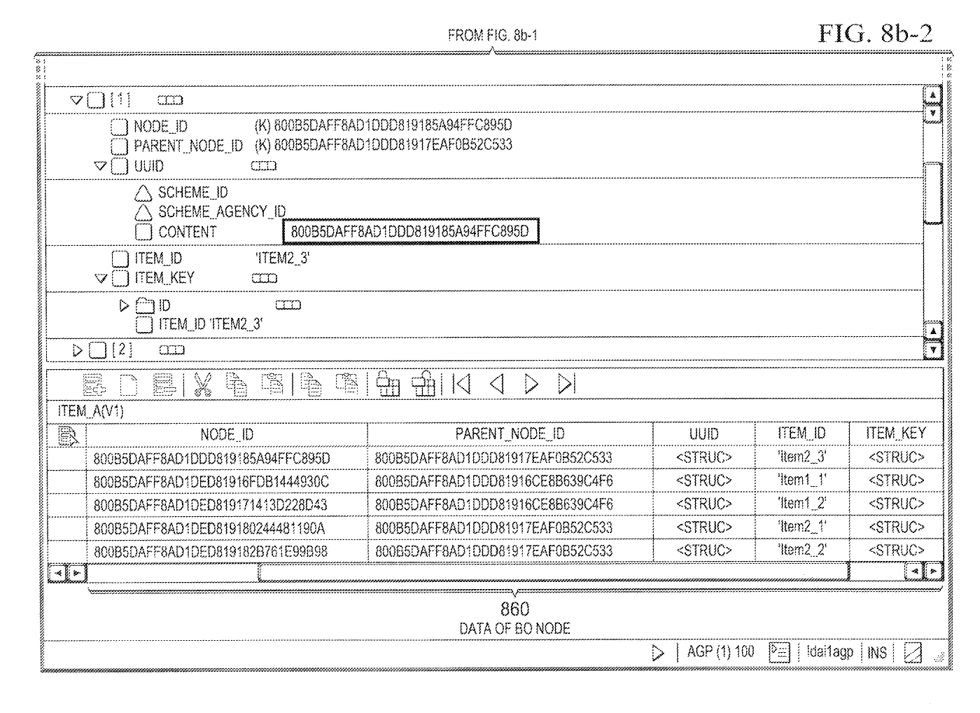

FIG. 8A shows an example screenshot 800 of the development of an embodiment of a test data container. The screenshot 800 shows the business object name field 805, as well as existing business object node instances 810 in the current or a remote system. FIG. 8B shows an example screenshot 850 of a generated test data container. The screenshot of FIG. 8B shows the business object nodes and their associations 855, as well as the data associated with the business object node 860.

A business object node (e.g., 855, also referred to herein as an object node or a node) refers to a component of a business object. For instance, “Purchase Order” may be a business object, while a “Purchase Order Item” (e.g., a product such as a screw) may be a business object node. Every business object node may be uniquely identified. Each node may be assigned an identification number, which typically is a technical identifier (referred to herein as an ID). The identifier may not be meaningful (or readable) to a human reader.

A business object node may have a text description stored in a text field. A text field is a data structure that holds alphanumeric data, such as a name or an address. A text node may be a business object node containing at least one text field. A description of a business object node may be stored as text in a text field of a text node. A business object node may have many text descriptions. For instance, if a business object node is a “product,” the product may map to various text descriptions. The product can be called “screw” in English, “Schraube” in German, and “tornillo” in Spanish, and so forth.

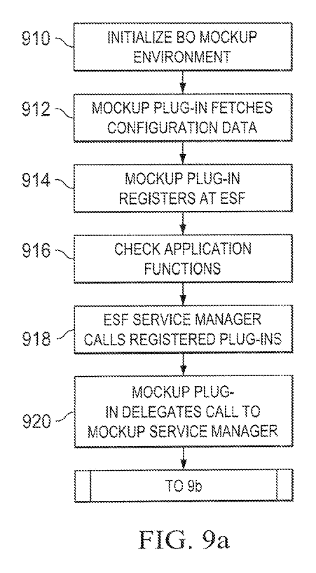

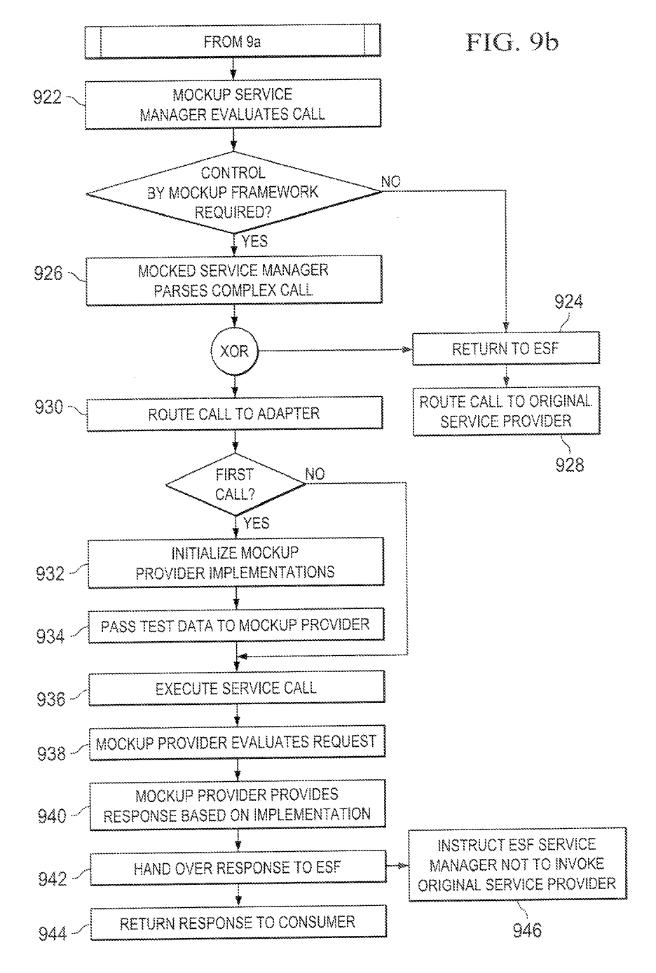

FIGS. 9A-B are process flowcharts 900 for implementing an embodiment of the mockup framework for executing testing and developing business objects. During the setup of a test, the business object mockup environment can be initialized [910]. In embodiments, the initialization can be performed using the business object mockup controller. This initialization, however, may not be necessary in configuration implementing static registration. The configuration of the mockup environment can be run statically or dynamically. In a statically configured framework, the mockup environment is always on, and tests can be run without having to switch on or initialize the mockup environment. In a dynamically configured framework, the test environment is switched on for single user and/or a single session. This can be done in a dynamic way such that after the unit test is executed and the service or the business object is later accessed, the simulation is not active. The mockup plug-in fetches all necessary configuration data from a data repository [912] and registers itself at the ESF service manager (dynamic registration) [914]. Dynamic registration with the ESF is unnecessary in static registration implementations. The test checks application functions that access the business object service provider functionality through the ESF [916]. The ESF service manager calls all registered plug-ins including the mockup plug-in before and after accessing the invoked business object service provider [918]. The mockup plug-in delegates the request and response of each core service call to the mockup service manager [920]. The mockup service manager evaluates the call and decides based on the mockup configuration on how to handle the call [922]. In case there is no mocked business object involved in the current call, the mockup service manager simply returns control back to the ESF service manager [924]. Otherwise the mockup service manager parses complex service calls into granular core service calls and orchestrates service invocations for complex or compound service calls [926]. The mockup service manager then dispatches the request to either the original service provider [928] via ESF or to the mockup providers [930]. In the latter case, the call is directed to an appropriate adapter class of the configured mockup provider. If this is the first call of the BO, the mockup provider is initialized [932] and test data is passed to the mockup service provider [934] before executing the service call [936]. Additional enhancement options allow application specific redefinitions of the standard generic mockup behavior. The mockup service provider evaluates the request [938] and provides the response based on its implementation [940]. In case of the generic BO mockup service providers all available metadata (enterprise service repository, fast search infrastructure etc.) is considered and used along with the test data that was initially passed to the mockup service provider. A generic buffer enables simulation of all business object instance transitions and images. An optional generic persistency allows to keep data permanently. After the response was constructed, it is handed over to the ESF service manager [942] which will return this information to its consumer [944]. In addition the BO mockup plug-in instructs the ESF service manager not to invoke the simulated original service provider [946].

The preceding figures and accompanying description illustrate processes and implementable techniques. But system 100 (or its other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, system 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. Software embodied in a computer-readable medium, the software comprising instructions being operable when executed to cause a processor to:
receive a request from a consumer for a business process performed by a business object service provider;
redirect the request to a simulated business object service provider framework, the simulated business object service provider framework providing a plurality of simulated business object service provider functionalities to perform the business process; and
process the request using the simulated business object service provider functionality to test business object functionality related to the request from the consumer or the business process.

2. The software of claim 1, wherein the plurality of simulated business object functionalities comprises a capture and replay functionality, operable to:
store in a database table information relating to a service call and a corresponding answer to the service call; and
upon receiving a simulated request for the service call, return the corresponding answer stored in the database table.

3. The software of claim 1, wherein the plurality of simulated business object functionalities comprises a generic simulated business object service provider functionality, wherein the generic simulated business object service provider functionality is operable to:
identify a simulated business object service provider stored in a database corresponding to the business process requested by the consumer; and
implement the identified simulated business object service provider to process the request.

4. The software of claim 3, wherein the generic simulated business object service provider functionality is operable to process the request using the identified simulated business object service provider and test data organized in test data containers stored in a repository located within the simulated business object service provider framework.

5. The software of claim 1, wherein the plurality of simulated business object functionalities comprises a specifically implemented business object service provider functionality.

6. The software of claim 5, wherein the specifically implemented business object service provider functionality is operable to:
determine the business process requested by the consumer;
define a simulated business object service provider based on the requested business process and metadata, stored on a repository, describing the requested business process; and
implement the simulated business object service provider to process the request.

7. The software of claim 1 further operable to direct the request to one of the requested business object service provider or the simulated business object service provider.

8. The software of claim 1 further operable to provide test data stored on a repository to the simulated business object service provider.

9. The software of claim 8, wherein:
the test data is organized as test data containers, the test data containers comprising test data associated with input parameters for each of the plurality of simulated business object service provider functionalities; and
the simulated business object service provider functionalities process the request from the consumer based on the test data.

10. The software of claim 9, wherein the test data containers comprise input parameters common to the plurality of simulated business object service provider functionalities.

11. The software of claim 9, wherein the test data containers comprise a subset of input parameters for one of the plurality of simulated business object service provider functionalities, and wherein the simulated business object service provider functionality accesses a plurality of test containers.

12. The software of claim 8, wherein the test data is generated from one or more existing business object instances stored on the repository.

13. The software of claim 1 further operable to provide a response to the request to the consumer based on results from the simulated business object service provider functionality processing.

14. Software embodied in a computer-readable medium, the software comprising instructions being operable when executed to cause a processor to:
instantiate a mockup business object service provider instance, the mockup business object service provider instance operable to perform a business process;
retrieve business process data from a data repository; and
provide the mockup business object service provider instance and the business process data to a business object testing environment, the business object testing environment selectively utilized during a business process execution to:
decouple a request for the business process directed to a production business object service provider operable to carry out the business process, and
perform the business process using the mockup business object service provider instance and the business process data.

15. The software of claim 14, wherein the software is further operable to:
communicate with an enterprise service framework, the enterprise service framework comprising a service manager module and a repository;
retrieve configuration information from the service manager to instantiate the mockup business object service provider instances; and
retrieve business object instance data from the repository.

16. The software of claim 14, further operable to instantiate the mockup business object service provider instance by identifying a generic mockup business object service provider, and wherein the business process data comprises metadata corresponding to the generic mockup business object service provider.

17. The software of claim 14 further operable to store the mockup business object service provider instance in a memory; and wherein providing the mockup business object service provider instance comprises retrieving the one or more mockup business object service provider instances from the memory.

18. The software of claim 14, wherein retrieving business object test data from a test data repository comprises:
retrieving business object test data from a business object service provider; and
storing the business object test data in the test data repository.
